(19) United States
(12) Patent Application Publication
(10) Pub. No.: US 2026/0126153 A1
(43) Pub. Date: May 7, 2026

(54) IOT SYSTEMS, METHODS, AND STORAGE MEDIA FOR DEHUMIDIFICATION MONITORING OF ANCILLARY FACILITIES IN SMART GAS PIPELINE NETWORKS

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Yunbai CHEN, Chengdu (CN); Lei ZHANG, Chengdu (CN)

(73) Assignee: CHENGDU QINCHUAN IOT TECHNOLOGY CO., LTD., Chengdu (CN)

(21) Appl. No.: 19/433,946

(22) Filed: Dec. 28, 2025

(30) Foreign Application Priority Data
Nov. 19, 2025 (CN) 202511695398.X

(51) Int. Cl. F17D 5/00; B01D 53/30; F17D 3/14

(52) U.S. Cl. CPC F17D 5/005; F17D 3/145; B01D 53/30

(57) ABSTRACT

A method, an IoT system, and a storage medium for dehumidification monitoring of an ancillary facility in a smart gas pipeline network are provided. The method comprises: obtaining humidity monitoring data collected by a gas equipment object platform, wherein the gas equipment object platform includes a humidity monitoring component and a dehumidification component; the humidity monitoring component is configured to monitor the humidity monitoring data, the dehumidification component is configured to dehumidify a pipeline vault; determining a dehumidification parameter based on the humidity monitoring data and a downstream feature of a gas pipeline, wherein the dehumidification parameter includes a self-cleaning cycle of the dehumidification component, and the downstream feature includes a gas usage frequency of downstream gas; and sending the dehumidification parameter to the dehumidification component, and controlling the dehumidification component to perform self-cleaning based on the dehumidification parameter.

### CROSS-REFERENCE TO RELATED APPLICATIONS

This application claims priority to Chinese Patent Application No. 202511695398.X, filed on Nov. 19, 2025, the entire contents of which are incorporated herein by reference.

### TECHNICAL FIELD

The present disclosure relates to the field of gas safety monitoring, and in particular, to an Internet of Things (IoT) system, a method, and a storage medium for dehumidification monitoring of an ancillary facility in a smart gas pipeline network.

### BACKGROUND

Humidity in gas pipelines may adversely affect the safe and reliable operation of ancillary facilities. For example, a high-humidity environment may accelerate the corrosion of metal components such as pipeline valves and pressure regulators, leading to reduced sealing performance or even gas leaks. Prolonged dampness inside pressure-regulating boxes may cause water blockages, dust blockages, or ice blockages, compromising gas supply stability. The humidity may also result in inaccurate monitoring data, false alarms, and degraded communication quality. With the widespread application of gas pipeline network systems, the impact of pipeline humidity on ancillary facilities has garnered increasing attention. Pipelines are typically equipped with pipeline vaults or access chambers to house various ancillary facilities, including valves, monitoring components, and communication modules. However, variations in environmental humidity across different pipeline sections lead to differing degrees of impact on ancillary facilities.

Therefore, it is desirable to provide an Internet of Things (IoT) system and a method for dehumidification monitoring of an ancillary facility in a smart gas pipeline network. The system is capable of determining appropriate dehumidification intensities for different ancillary facilities at different times and performing dehumidification operations on gas pipelines.

### SUMMARY

One or more embodiments of the present disclosure provide an Internet of Things (IoT) system for dehumidification monitoring of an ancillary facility in a smart gas pipeline network. The IoT system includes: a government safety supervision management platform, a government safety supervision sensor network platform, a government safety supervision object platform, a gas company sensor network platform, a gas equipment object platform, and a gas maintenance object platform. The gas equipment object platform includes a humidity monitoring component and a dehumidification component. The humidity monitoring component is configured to collect humidity monitoring data. The humidity monitoring data includes at least one of a pipeline environment humidity level or a pipeline vault humidity level. The dehumidification component is configured to dehumidify a pipeline vault. The gas maintenance object platform includes an interactive device. The government safety supervision management platform is configured to: based on the government safety supervision sensor network platform, obtain, through the government safety supervision object platform and from the gas company sensor network platform, the humidity monitoring data collected by the gas equipment object platform; determine a dehumidification parameter based on the humidity monitoring data and a downstream feature of a gas pipeline, wherein the dehumidification parameter includes a self-cleaning cycle of the dehumidification component, and the downstream feature includes a gas usage frequency of downstream gas; and send the dehumidification parameter to the dehumidification component, and control the dehumidification component to perform self-cleaning based on the dehumidification parameter.

One or more embodiments of the present disclosure provide a method for dehumidification monitoring of an ancillary facility in a smart gas pipeline network, executed by a government safety supervision management platform of an Internet of Things (IoT) system for dehumidification monitoring of the ancillary facility in the smart gas pipeline network. The method includes: based on a government safety supervision sensor network platform, obtaining, through a government safety supervision object platform and from a gas company sensor network platform, humidity monitoring data collected by a gas equipment object platform, wherein the gas equipment object platform includes a humidity monitoring component and a dehumidification component, the humidity monitoring component is configured to monitor the humidity monitoring data, the humidity monitoring data includes at least one of a pipeline environment humidity level or a pipeline vault humidity level, the dehumidification component is configured to dehumidify a pipeline vault, and a gas maintenance object platform of the IoT system includes an interactive device; determining a dehumidification parameter based on the humidity monitoring data and a downstream feature of a gas pipeline, wherein the dehumidification parameter includes a self-cleaning cycle of the dehumidification component, and the downstream feature includes a gas usage frequency of downstream gas; and sending the dehumidification parameter to the dehumidification component, and controlling the dehumidification component to perform self-cleaning based on the dehumidification parameter.

One or more embodiments of the present disclosure provide a non-transitory computer-readable storage medium storing computer instructions, wherein after reading the computer instructions in the storage medium, a computer executes the method for dehumidification monitoring of an ancillary facility in a smart gas pipeline network described in one or more embodiments of the preset disclosure.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is a schematic diagram illustrating a platform structure of an IoT system for dehumidification monitoring of an ancillary facility in a smart gas pipeline network according to some embodiments of the present disclosure;

FIG. 2 is a flowchart illustrating an exemplary process for dehumidification monitoring of an ancillary facility in a smart gas pipeline network according to some embodiments of the present disclosure;

FIG. 3 is a flowchart illustrating an exemplary process for determining a dehumidification parameter according to some embodiments of the present disclosure; and

FIG. 4 is a schematic diagram illustrating the determination of a dehumidification parameter according to some embodiments of the present disclosure.

### DETAILED DESCRIPTION

In order to provide a clearer understanding of the technical solutions of the embodiments described in the present disclosure, a brief introduction to the drawings required in the description of the embodiments is given below. It is evident that the drawings described below are merely some examples or embodiments of the present disclosure, and for those skilled in the art, the present disclosure may be applied to other similar situations without exercising creative labor. Unless otherwise indicated or stated in the context, the same reference numerals in the drawings represent the same structures or operations.

It should be understood that the terms “system,” “device,” “unit,” and/or “module” used herein are ways for distinguishing different levels of components, elements, parts, or assemblies. However, if other terms can achieve the same purpose, they may be used as alternatives.

As indicated in the present disclosure and in the claims, the singular forms “a,” “an,” and “the” may be intended to include the plural forms as well, unless the context clearly indicates otherwise. In general, the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof. The term “and/or”, as used herein, is merely a way of describing the associative relationship of an associated object, indicating that three relationships can exist, e.g., A and/or B, which may be represented as: An alone, both A and B, and B alone.

Flowcharts are used in the present disclosure to illustrate the operations performed by the system according to the embodiments described herein. It should be understood that the operations may not necessarily be performed in the exact sequence depicted. Instead, the operations may be performed in reverse order or concurrently.

Additionally, other operations may be added to these processes, or one or more operations may be removed.

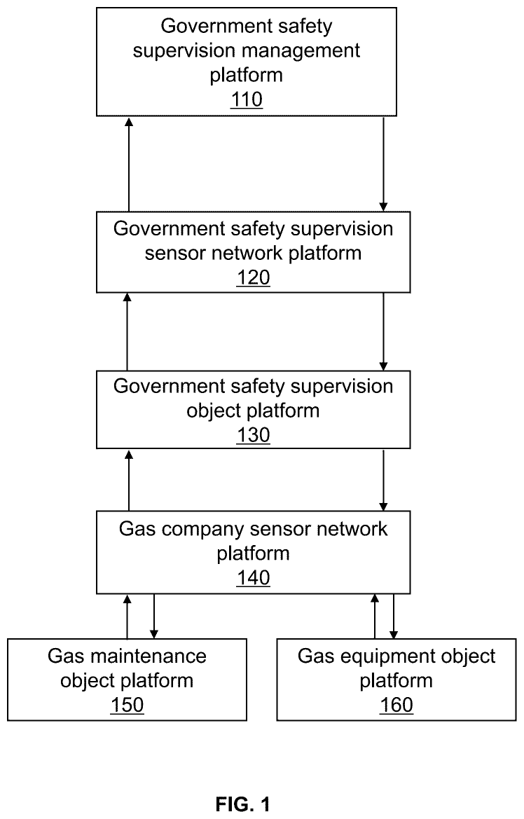

FIG. 1 is a schematic diagram illustrating a platform structure of an IoT system for dehumidification monitoring of an ancillary facility in a smart gas pipeline network according to some embodiments of the present disclosure.

As shown in FIG. 1, in some embodiments, the IoT system for dehumidification monitoring of an ancillary facility in a smart gas pipeline network includes a government safety supervision management platform 110, a government safety supervision sensor network platform 120, a government safety supervision object platform 130, a gas company sensor network platform 140, a gas maintenance object platform 150, and a gas equipment object platform 160.

The government safety supervision management platform 110 refers to a platform for governmental supervision and management, which may be configured as a processor or a server. In some embodiments, the processor may include one or more sub-processing devices (e.g., single-core processing devices, multi-core multi-chip processing devices, etc.). Merely by way of example, the processor may include a Central Processing Unit (CPU), an Application-Specific Integrated Circuit (ASIC), or the like, any combination thereof.

In some embodiments, the government safety supervision management platform 110 may be communicatively connected to the government safety supervision object platform 130 via the government safety supervision sensor network platform 120. For example, the government safety supervision object platform 130 may transmit humidity monitoring data to the government safety supervision management platform 110 through the government safety supervision sensor network platform 120. The humidity monitoring data is collected by the gas equipment object platform 160.

In some embodiments, the government safety supervision management platform 110 is configured to: based on the government safety supervision sensor network platform 120, obtain, through the government safety supervision object platform 130 and from the gas company sensor network platform 140, the humidity monitoring data collected by the gas equipment object platform 160; determine a dehumidification parameter based on the humidity monitoring data and a downstream feature of a gas pipeline, wherein the dehumidification parameter includes a self-cleaning cycle of the dehumidification component, and the downstream feature includes a gas usage frequency of downstream gas; and send the dehumidification parameter to the dehumidification component, and control the dehumidification component to perform self-cleaning based on the dehumidification parameter.

In some embodiments, the government safety supervision management platform 110 is further configured to: obtain terrain data, wherein the terrain data includes an altitude; determine a humidity impact coefficient of the pipeline vault based on the terrain data and the humidity monitoring data; and determine the dehumidification parameter based on the humidity impact coefficient of the pipeline vault and the downstream feature of the gas pipeline.

In some embodiments, the government safety supervision management platform 110 is further configured to: determine the humidity impact coefficient of the pipeline vault through a coefficient determination model based on a gas transmission parameter of the gas pipeline, the terrain data, and the humidity monitoring data, the coefficient determination model being a machine learning model.

In some embodiments, the government safety supervision management platform 110 is further configured to: determine future humidity monitoring data based on the humidity monitoring data; and determine the dehumidification parameter based on the future humidity monitoring data and the downstream feature of the gas pipeline.

In some embodiments, the government safety supervision management platform 110 is further configured to: determine the future humidity monitoring data through a humidity prediction model based on the humidity monitoring data, an ancillary facility feature, terrain data, a consumable type of the dehumidification consumable, a gas transmission parameter of the gas pipeline, and a previous replacement time of the dehumidification consumable, the humidity prediction model being a machine learning model.

In some embodiments, the government safety supervision management platform 110 is further configured to: determine a humidity impact coefficient of the pipeline vault based on the future humidity monitoring data; determine a pipeline vault importance value of the pipeline vault based on the downstream feature of the gas pipeline; and determine whether the dehumidification consumable requiring replacement exists in the pipeline vault based on the humidity impact coefficient of the pipeline vault, the pipeline vault importance value, and an impact threshold.

In some embodiments, the government safety supervision management platform 110 is further configured to: determine whether the dehumidification consumable requiring replacement exists in the pipeline vault based on the humidity impact coefficient, the impact threshold, the pipeline vault importance value, and an impact reliability value, wherein the impact reliability value is related to the humidity impact coefficient and the consumable type of the dehumidification consumable.

The government safety supervision sensor network platform 120 refers to a platform for the government to supervise and manage sensor network information. The government safety supervision sensor network platform 120 may be configured as a communication device or a server.

In some embodiments, the government safety supervision sensor network platform 120 may be configured to facilitate communication interactions between the government safety supervision management platform 110 and the government safety supervision object platform 130.

The government safety supervision object platform 130 refers to a platform capable of comprehensive management of gas companies, which may be configured as a processor or a server.

In some embodiments, the government safety supervision object platform 130 is communicatively connected upstream to the government safety supervision management platform 110 via the government safety supervision sensor network platform 120, and connected downstream to the gas maintenance object platform 150 and the gas equipment object platform 160 via the gas company sensor network platform 140. For example, the government safety supervision object platform 130 may transmit humidity monitoring data to the gas maintenance object platform 150 and send dehumidification commands to the gas equipment object platform 160 through the gas company sensor network platform 140.

The gas company sensor network platform 140 refers to a platform for managing sensor information of a gas company, which may be configured as a communication device or a server. In some embodiments, the gas company sensor network platform 140 may be configured to facilitate communication interactions between the government safety supervision object platform 130 and the gas maintenance object platform 150 as well as the gas equipment object platform 160.

The gas maintenance object platform 150 refers to a platform for interaction with gas maintenance personnel, which may be configured as an application (APP) client or a server. The gas maintenance personnel are individuals associated with gas maintenance, such as a pipeline repair technician, a pipeline inspector, etc.

The gas equipment object platform 160 refers to a functional platform for generating sensed information and executing control commands within the gas company, which may be configured as control components. In some embodiments, the gas equipment object platform 160 may include a humidity monitoring component and a dehumidification component. The humidity monitoring component includes a humidity sensor for obtaining the humidity monitoring data, or the like. The dehumidification component may include dehumidification equipment such as a dehumidifier, etc.

In some embodiments of the present disclosure, based on the IoT system for dehumidification monitoring of an ancillary facility in a smart gas pipeline network, an operational information closed loop can be formed among the various functional platforms.

Under the unified management of the government safety supervision management platform, these platforms operate in a coordinated and regular manner, achieving smart and information-based dehumidification of ancillary facilities within the smart gas pipeline network.

It should be noted that the foregoing descriptions of the IoT system for dehumidification monitoring of an ancillary facility in a smart gas pipeline network and its modules are provided for illustrative convenience only and shall not limit the present disclosure to the specific embodiments described. It may be understood that those skilled in the art, upon understanding the principles of the system, may make various combinations of modules or form subsystems connected with other modules without departing from these principles. In some embodiments, the government safety supervision management platform, the government safety supervision sensor network platform, the government safety supervision object platform, the gas company sensor network platform, the gas maintenance object platform, and the gas equipment object platform disclosed in FIG. 1 may represent distinct modules within a single system, or a single module may implement the functions of two or more modules described above. For example, multiple modules may share a common storage module, or each module may have its own dedicated storage module. Such modifications and similar arrangements fall within the scope of protection of the present disclosure.

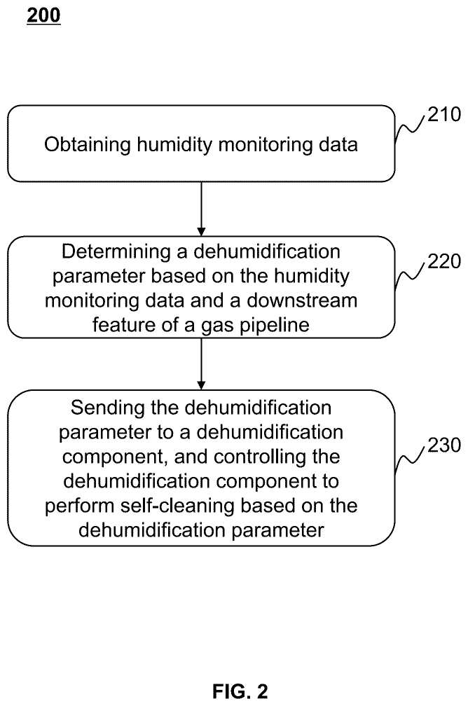

FIG. 2 is a flowchart illustrating an exemplary process for dehumidification monitoring of an ancillary facility in a smart gas pipeline network according to some embodiments of the present disclosure. As shown in FIG. 2, process 200 includes the following steps. In some embodiments, process 200 may be executed by a government safety supervision management platform (e.g., the by a government safety supervision management platform 110).

In 210, obtaining humidity monitoring data.

The humidity monitoring data refers to data obtained by monitoring the humidity of the gas pipeline network. The humidity monitoring data includes at least one of a pipeline environment humidity level or a pipeline vault humidity level.

In some embodiments, pipeline vaults are installed at intervals along a gas pipeline to accommodate various ancillary facilities. For example, the ancillary facilities include a valve, a monitoring component, a communication component, an alarm component, a pressure and flow regulation device, a sampling and maintenance component, etc.

The pipeline environment humidity level refers to a humidity level inside the gas pipeline.

The pipeline vault humidity level refers to a humidity level inside the pipeline vault.

In some embodiments, based on a government safety supervision sensor network platform, the government safety supervision management platform obtains the humidity monitoring data through a government safety supervision object platform and from a gas company sensor network platform. The humidity monitoring data is collected by a humidity monitoring component in a gas equipment object platform (e.g., the gas equipment object platform 160). More descriptions regarding the humidity monitoring component and the platforms may be found in FIG. 1 and the related descriptions.

In 220, determining a dehumidification parameter based on the humidity monitoring data and a downstream feature of the gas pipeline.

The downstream feature of the gas pipeline refers to one or more features related to gas usage by one or more users downstream of the gas pipeline. For example, the downstream feature of the gas pipeline includes at least a gas usage frequency of downstream gas.

The gas usage frequency of downstream gas refers to a frequency at which gas user(s) downstream of the gas pipeline use the gas.

In some embodiments, the government safety supervision management platform obtains the downstream feature of the gas pipeline from the government safety supervision object platform via the government safety supervision sensor network platform.

The dehumidification parameter refers to one or more operating parameters of dehumidification component(s) during dehumidification. For example, the dehumidification parameter includes a self-cleaning cycle of at least one dehumidification component. For more details on the self-cleaning cycle, please refer to the following sections

In some embodiments, the government safety supervision management platform constructs reference vectors based on historical humidity monitoring data and downstream features of historical gas pipelines from historical dehumidification processes with effective dehumidification results in historical data. Then the government safety supervision management platform determines actual dehumidification parameters of the dehumidification component during the historical dehumidification processes as reference labels corresponding to the reference vectors, and builds a reference vector database based on a plurality of reference vectors and their reference labels.

The government safety supervision management platform constructs a target vector based on current humidity monitoring data and the downstream feature of the current gas pipeline. The government safety supervision management platform then matches the target vector against the reference vector database to identify a reference vector with the highest similarity to the target vector, and determines the reference label corresponding to the reference vector as the current dehumidification parameter. The similarity may be determined based on vector distance, which includes but is not limited to cosine distance.

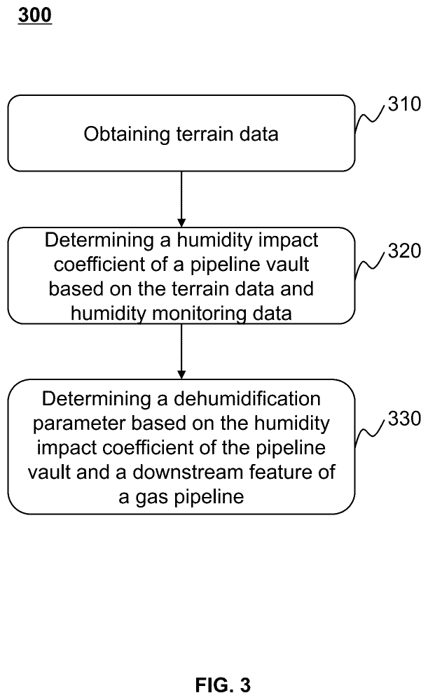

In some embodiments, the dehumidification parameter further includes a self-cleaning intensity of the dehumidification component. The government safety supervision management platform obtains terrain data, determines a humidity impact coefficient of the pipeline vault based on the terrain data and humidity monitoring data, and determines the dehumidification parameter based on the humidity impact coefficient of the pipeline vault and the downstream feature of the gas pipeline. For more details, please refer to FIG. 3 and related descriptions.

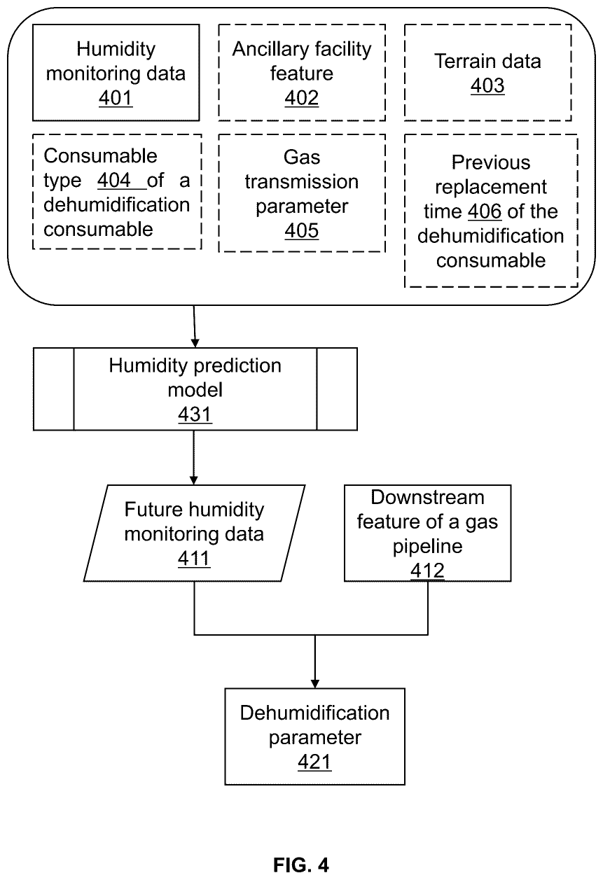

In some embodiments, the dehumidification component also includes a dehumidification consumable, and the dehumidification parameter further includes a dehumidification consumable requiring replacement. The government safety supervision management platform is configured to determine future humidity monitoring data based on the humidity monitoring data (i.e., the current humidity monitoring data), and determine the dehumidification parameter based on the future humidity monitoring data and the downstream feature of the gas pipeline. The future humidity monitoring data is also referred to humidity monitoring data for a future time period. The future time period is defined relative to the current time when the current humidity monitoring data is obtained. For more details, please refer to FIG. 4 and related descriptions.

In 230, sending the dehumidification parameter to the dehumidification component, and controlling the dehumidification component to perform self-cleaning based on the dehumidification parameter.

In some embodiments, the dehumidification component may perform self-cleaning based on the dehumidification parameter.

By way of example, a workflow of the dehumidification component includes: drawing in moist air through a fan, adsorbing water droplets through the dehumidification consumable, and discharging the processed dry air. The dehumidification component can eliminate adsorbed water droplets through self-cleaning.

The self-cleaning cycle of the dehumidification component refers to a period at which the dehumidification component eliminates adsorbed water droplets through self-cleaning. In some embodiments, the dehumidification parameter further includes the self-cleaning intensity of the dehumidification component. The self-cleaning intensity of the dehumidification component refers to the power at which the dehumidification component eliminates adsorbed water droplets through self-cleaning.

In some embodiments, the dehumidification component performs self-cleaning by heating itself to evaporate the adsorbed water droplets. In this case, the self-cleaning cycle of the dehumidification component is the period at which the dehumidification component heats itself, and the self-cleaning intensity of the dehumidification component is the power at which the dehumidification component heats itself.

The above description of the dehumidification component's workflow is for illustrative purposes only. The dehumidification component may perform dehumidification and self-cleaning through any feasible manner, which is not limited in the present disclosure.

In some embodiments of the present disclosure, by determining the self-cleaning cycle of the dehumidification component, the dehumidification component is maintained in good condition, which facilitates more effective dehumidification in subsequent operations and ensures the normal use of the ancillary facility.

It should be noted that the above description of process 200 is merely for exemplary and explanatory purposes and does not limit the applicable scope of the present disclosure. Those skilled in the art may make various modifications and changes to process 200 under the guidance of the present disclosure. However, these modifications and changes still fall within the scope of the present disclosure.

FIG. 3 is a flowchart illustrating an exemplary process for determining a dehumidification parameter according to some embodiments of the present disclosure. As shown in FIG. 3, process 300 includes the following steps. In some embodiments, process 300 may be executed by a government safety supervision management platform (e.g., the government safety supervision management platform 110).

In 310, obtaining terrain data.

The terrain data refers to data related to the topography of a location where a gas pipeline network and/or a pipeline vault is located. For example, the terrain data includes an altitude of the location where the gas pipeline network and/or the pipeline vault is located.

In some embodiments, the government safety supervision management platform acquires the terrain data from a government safety supervision object platform (e.g., the government safety supervision object platform 130) through a government safety supervision sensor network platform (e.g., the government safety supervision sensor network platform 120).

In 320, determine a humidity impact coefficient of the pipeline vault based on the terrain data and humidity monitoring data.

For more details regarding the humidity monitoring data, please refer to the descriptions related to FIG. 2.

The humidity impact coefficient is used to measure a degree of impact of a current humidity level on an ancillary facility. The higher the humidity impact coefficient is, the more the ancillary facility is prone to issues (e.g., oxidation, corrosion, etc.).

In some embodiments, the government safety supervision management platform determines the humidity impact coefficient by querying a first preset table based on the terrain data and the humidity monitoring data.

The first preset table includes a correspondence between combinations of terrain data and humidity monitoring data, and a humidity impact coefficient corresponding to each of the combinations.

In some embodiments, for each combination of terrain data and humidity monitoring data, the government safety supervision management platform counts the total count of data entries corresponding to the combination in the historical data, as well as the count of data entries where failures occurred within a subsequent preset period. The ratio of the count of failure data entries to the total count of data entries is determined as the humidity impact coefficient corresponding to the combination, thereby obtaining the first preset table. The duration of the preset period may be set based on experience. The failures include malfunctions of the ancillary facility and pipeline failures caused by adjustments made by the ancillary facility.

In some embodiments, the government safety supervision management platform determines the humidity impact coefficient of the pipeline vault through a coefficient determination model based on a gas transmission parameter of the gas pipeline, the terrain data, and the humidity monitoring data.

The coefficient determination model is a model configured to determine the humidity impact coefficient of the pipeline vault. In some embodiments, the coefficient determination model is a machine learning model, such as a Deep Neural Network (DNN) model.

An input of the coefficient determination model may include the gas transmission parameter of the gas pipeline, the terrain data, and the humidity monitoring data. An output of the coefficient determination model is the humidity impact coefficient of the pipeline vault.

The gas transmission parameter refers to one or more parameters related to the gas transmission within the gas pipeline. For example, the gas transmission parameter includes a gas flow rate and a gas temperature.

In some embodiments, based on the government safety supervision sensor network platform, the government safety supervision management platform acquires the gas flow rate and the gas temperature from a gas company sensor network platform (e.g., the gas company sensor network platform 140) through the government safety supervision object platform. The gas flow rate is collected by a gas flow meter within a gas equipment object platform (e.g., the gas equipment object platform 160), and the gas temperature is collected by a temperature sensor within the gas equipment object platform.

In some embodiments, the government safety supervision management platform obtains the coefficient determination model through training based on a plurality of first training samples with first labels. For example, the government safety supervision management platform may input the plurality of first training samples into an initial coefficient determination model, construct a first loss function based on the model's output and the first labels, and iteratively update parameters of the initial model based on the loss function. The iteration continues until a completion condition is met, thereby obtaining the trained coefficient determination model. The completion condition may include the loss function converging, the count of iterations reaching a threshold, etc. The iterative update manners include, but are not limited to, gradient descent.

Each first training sample includes a sample gas transmission parameter of a gas pipeline where a sample pipeline vault is located or to which the sample pipeline vault belongs, sample terrain data of the sample pipeline vault, and sample humidity monitoring data of the sample pipeline vault. The first training samples may be obtained from historical data. The government safety supervision management platform determines a humidity impact coefficient of the sample pipeline vault corresponding to each first training sample using the humidity impact coefficient determination manner described above, and designates the humidity impact coefficient as the first label for the corresponding first training sample.

In some embodiments, the input of the coefficient determination model further includes an ancillary facility feature and future humidity monitoring data.

The ancillary facility feature refers to one or more features related to the ancillary facility. For example, the ancillary facility feature includes an ancillary facility type. For more details on the ancillary facility, please refer to FIG. 2 and the related descriptions.

For more details on the future humidity monitoring data, please refer to FIG. 4 and the related descriptions.

In some embodiments, when the input of the coefficient determination model includes the ancillary facility feature and the future humidity monitoring data, the first training sample consists of a sample gas transmission parameter of the gas pipeline where the sample pipeline vault is located or to which the sample pipeline vault belongs, sample terrain data of the sample pipeline vault, sample humidity monitoring data of the sample pipeline vault, and a sample ancillary facility feature of the sample pipeline vault in a first historical period, along with sample humidity monitoring data of the sample pipeline vault in a second historical period. The first historical period precedes the second historical period.

Different pipeline vaults contain different ancillary facilities, and different ancillary facility types (i.e., different types of ancillary facilities) have varying humidity requirements. Some embodiments of the present disclosure take into account the influence of the types of ancillary facilities within the pipeline vault when determining the humidity impact coefficient, resulting in a more accurate humidity impact coefficient.

Some embodiments of the present disclosure determine the humidity impact coefficient based on both the current humidity monitoring data and the future humidity monitoring data. This approach allows for consideration of the impact of future humidity changes on the ancillary facility, thereby obtaining a more accurate humidity impact coefficient.

In some embodiments, the government safety supervision management platform validates the initially trained model using a validation set and tests the model that passed the validation using a test set. The initial model that passes the testing with the test set is designated as the coefficient determination model.

In some embodiments, the training set is a dataset used to adjust a learnable parameter of the coefficient determination model during the training process. The learnable parameter includes weights, biases, or the like. The validation set is a dataset used to adjust a hyperparameter of the coefficient determination model during the training process. The hyperparameter includes a count of network layers, a count of nodes per layer, a count of iterations, a learning rate, etc. The test set is a dataset used to evaluate the performance of the final model.

In some embodiments, the government safety supervision management platform divides the plurality of first training samples, each with its first label, into one of the following datasets: the training set, the validation set, or the test set. The data volumes of the training set, validation set, and test set form a first preset ratio.

The ratio of the data volumes of the training set, the validation set, and the test set may affect the training outcome of the coefficient determination model. In some embodiments, the first preset ratio is 8:1:1.

There is no data overlap among the training set, the validation set, and the test set. In other words, there are no duplicate samples in the training set, the validation set, and the test set.

In some embodiments, during the training of the initial coefficient determination model, different first training samples have different learning rates.

The learning rate of a first training sample reflects a degree of influence that the first training sample has on the model training. In some embodiments, the government safety supervision management platform adjusts the learning rate of a first training sample based on maintenance data of a sample ancillary facility corresponding to the first training sample. The more maintenance data available for the sample ancillary facility, the higher the learning rate assigned to the first training sample.

Some embodiments of the present disclosure employ a cross-validation approach to train the coefficient determination model, which can enhance the model's stability and accuracy.

In 330, determining dehumidification parameters based on the humidity impact coefficient of the pipeline vault and the downstream feature of the gas pipeline.

In some embodiments, the government safety supervision management platform determines the self-cleaning intensity of the dehumidification component based on the humidity impact coefficient of the pipeline vault, and determines the self-cleaning cycle of the dehumidification component based on the downstream feature of the gas pipeline. For example, the higher the humidity impact coefficient of the pipeline vault is, the greater the self-cleaning intensity of the dehumidification component is; the higher the gas usage frequency of downstream gas is, the shorter the self-cleaning cycle of the dehumidification component is. The government safety supervision management platform combines the self-cleaning cycle and self-cleaning intensity of the dehumidification component to obtain the dehumidification parameter.

When the dehumidification component does not perform self-cleaning for an extended period, its dehumidification capacity decreases, leading to an increase in humidity. To ensure the normal operation of the ancillary facility, the dehumidification component needs to perform self-cleaning. Some embodiments of the present disclosure adjust the self-cleaning cycle and the self-cleaning intensity of the dehumidification component based on the degree of impact of humidity on the ancillary facility, enabling different levels of dryness to be maintained for different pipeline vaults and conserving energy.

It should be noted that the above description of process 300 is merely for exemplary and explanatory purposes and does not limit the applicable scope of the present disclosure. Those skilled in the art may make various modifications and changes to process 300 under the guidance of the present disclosure. However, these modifications and changes still fall within the scope of the present disclosure.

FIG. 4 is a schematic diagram illustrating the determination of a dehumidification parameter according to some embodiments of the present disclosure.

In some embodiments, the dehumidification component further includes a dehumidification consumable, and the dehumidification parameter further includes a dehumidification consumable requiring replacement.

The dehumidification consumable is configured to adsorb water droplets from humid air. Types of the dehumidification consumable include, but are not limited to, hygroscopic agents such as silica gel and calcium chloride.

The water droplet adsorption capacity of the dehumidification consumable diminishes over time. Therefore, to ensure the dehumidification capability of the dehumidification component, the dehumidification consumable must be replaced in a timely manner.

In some embodiments, as shown in FIG. 4, the government safety supervision management platform determines future humidity monitoring data 411 based on humidity monitoring data 401, and determines a dehumidification parameter 421 based on the future humidity monitoring data 411 and a downstream feature 412 of a gas pipeline.

More descriptions regarding the humidity monitoring data, the downstream feature of the gas pipeline, and the dehumidification parameter may be found in the description related to FIG. 2.

In some embodiments, the government safety supervision management platform retrieves from a second preset lookup table based on the humidity monitoring data 401 to determine the future humidity monitoring data 411.

The second preset lookup table includes a correspondence relationship between the humidity monitoring data 401 and the future humidity monitoring data 411. The second preset lookup table may be constructed based on historical data. In some embodiments, the government safety supervision management platform acquires historical humidity monitoring data from a historical time point, and defines humidity monitoring data from a predetermined period subsequent to the historical time point as the future humidity monitoring data corresponding to the historical humidity monitoring data. The duration of the predetermined period may be established based on empirical knowledge.

In some embodiments, as shown in FIG. 4, the government safety supervision management platform determines the future humidity monitoring data 411 by processing the humidity monitoring data 401, an ancillary facility feature 402, terrain data 403, a consumable type 404 of the dehumidification consumable, a gas transmission parameter 405 of the gas pipeline, and a previous replacement time 406 of the dehumidification consumable through a humidity prediction model 431.

More descriptions regarding the ancillary facility feature, the terrain data, and the gas transmission parameter of the gas pipeline may be found in FIG. 3 and the related descriptions.

The humidity prediction model 431 is a model configured to determine the future humidity monitoring data 411. In some embodiments, the humidity prediction model 431 is a machine learning model, such as a Deep Neural Network (DNN) model.

An input of the humidity prediction model 431 may include the humidity monitoring data 401, the ancillary facility feature 402, the terrain data 403, the consumable type 404 of the dehumidification consumable, the gas transmission parameter 405 of the gas pipeline, and the previous replacement time 406 of the dehumidification consumable. An output of the humidity prediction model 431 includes the future humidity monitoring data 411.

In some embodiments, the government safety supervision management platform acquires the consumable type 404 and the previous replacement time 406 of the dehumidification consumable from a government safety supervision object platform (e.g., the government safety supervision object platform 130) through a government safety supervision sensor network platform (e.g., the government safety supervision sensor network platform 120).

In some embodiments, the government safety supervision management platform obtains the trained humidity prediction model by training using a plurality of second training samples with second labels. For example, the government safety supervision management platform trains the humidity prediction model using the manner for obtaining the coefficient determination model as described in FIG. 3. For further details regarding the training of the coefficient determination model, please refer to FIG. 3 and its related description.

The second training sample may include sample humidity monitoring data of a sample pipeline vault at a first historical time, a sample ancillary facility feature of a sample ancillary facility within the sample pipeline vault, sample terrain data, a consumable type of a sample dehumidification consumable within the sample pipeline vault, a gas transmission parameter of a gas pipeline where the sample pipeline vault is located or to which the sample pipeline vault belongs, and a previous replacement time of the sample dehumidification consumable within the sample pipeline vault. The second training sample may be acquired based on historical data. The government safety supervision management platform may designate historical humidity monitoring data of the sample pipeline vault at a second historical time as the second label corresponding to the second training sample. The first historical time is earlier than the second historical time.

In some embodiments, the government safety supervision management platform determines the dehumidification consumable requiring replacement by performing a retrieval in a third preset lookup table based on the future humidity monitoring data 411 and the downstream feature 412 of the gas pipeline.

The third preset lookup table stores mappings between combinations of input parameters (including future humidity monitoring data 411 and downstream features 412 of the gas pipeline) and a dehumidification consumable requiring replacement corresponding to each of the combinations. The third preset lookup table may be constructed based on experience.

The government safety supervision management platform obtains the dehumidification parameter 421 by combining the dehumidification consumable requiring replacement with the self-cleaning cycle and the self-cleaning intensity of the dehumidification component determined via the manners described in FIG. 2 and FIG. 3.

In some embodiments of the present disclosure, by predicting the future humidity monitoring data and determining the dehumidification consumable requiring replacement based on the future humidity monitoring data and the downstream feature of the gas pipeline, the dehumidification consumable requiring replacement can be replaced in a timely manner before the dehumidification capability of the dehumidification component degrades, thereby ensuring the normal operation of the ancillary facility.

In some embodiments, the government safety supervision management platform determines a humidity impact coefficient of a pipeline vault based on the future humidity monitoring data, determines a pipeline vault importance value based on the downstream feature of the gas pipeline, and determines whether the dehumidification consumable requiring replacement exists in the pipeline vault based on the humidity impact coefficient of the pipeline vault, the pipeline vault importance value, and an impact threshold.

For further details regarding the humidity impact coefficient, please refer to FIG. 3 and its related description.

In some embodiments, the government safety supervision management platform determines the humidity impact coefficient of the pipeline vault based on the future humidity monitoring data. For example, the government safety supervision management platform determines the humidity impact coefficient using Equation (1):

$${P}_{2} = ( \frac{{k}_{1} ( {w}_{f 1} - {w}_{n 1} )}{{w}_{n 1}} + \frac{{k}_{2} ( {w}_{f 2} - {w}_{n 2} )}{{w}_{n 2}} ) \times \qquad ( 1 )$$

wherein P₂ denotes the humidity impact coefficient, w_{f1} denotes a pipeline environment humidity level in a future time period, wₙ₁ denotes a current pipeline environment humidity level, w_{f2} denotes a pipeline vault humidity level in the future time period, wₙ₂ denotes a current pipeline vault humidity level, avg(S) denotes an average value of humidity sensitivity levels of all ancillary facilities within the pipeline vault. k₁ and k₂ are coefficients. The coefficients k₁ and k₂ may be set empirically.

The humidity sensitivity level of an ancillary facility reflects a degree to which the ancillary facility is affected by humidity. The more susceptible an ancillary facility is to damage from humidity, the higher the humidity sensitivity of the ancillary facility is.

In some embodiments, the humidity sensitivity level may also be determined experimentally. For example, laboratory personnel may place an ancillary facility in environments with different humidity levels, record the time until complete corrosion damage occurs at each humidity level, construct a humidity-versus-corrosion-time curve, and determine an average curvature of the curve as the humidity sensitivity level of the ancillary facility.

In some embodiments, the government safety supervision management platform may also determine the humidity impact coefficient using the manner described in FIG. 3.

The pipeline vault importance value indicates an importance level of the pipeline vault. The higher the pipeline vault importance value of a pipeline vault is, the greater the importance level of the pipeline vault is (i.e., the more important the pipeline vault is).

In some embodiments, the pipeline vault importance value correlates with the gas usage frequency of downstream gas. The higher the gas usage frequency of downstream gas is, the greater the pipeline vault importance value is.

In some embodiments, the pipeline vault importance value is further related to a facility criticality value of the ancillary facility. The greater the facility criticality value of the ancillary facility is, the greater the pipeline vault importance value is.

The facility criticality value indicates the importance level of the ancillary facility.

In some embodiments, the facility criticality value is related to the count of associated downstream branches of the ancillary facility and historical maintenance timeliness of the ancillary facility. For example, the facility criticality value is a weighted sum of the count of associated downstream branches and the historical maintenance timeliness. Weights for the count of associated downstream branches and the historical maintenance timeliness may be set empirically.

The count of associated downstream branches refers to the quantity of downstream gas pipelines affected by the ancillary facility. The government safety supervision management platform may determine the count of associated downstream branches for the ancillary facility based on a distribution of gas pipelines.

The historical maintenance timeliness refers to the timeliness of maintenance performed on the ancillary facility in historical data. In some embodiments, the government safety supervision management platform may determine the historical maintenance timeliness based on an average duration between fault reporting and multiple instances of maintenance for the ancillary facility. The greater the average duration is, the lower the historical maintenance timeliness is.

In some embodiments, the government safety supervision management platform determines the pipeline vault importance value by performing a weighted summation based on an average facility criticality value of all ancillary facilities within the pipeline vault and the gas usage frequency of downstream gas. Weights for the weighted summation may be set empirically.

The impact threshold is a threshold for determining whether replacement of a dehumidification consumable is required.

In some embodiments, the impact threshold is related to the consumable type of the dehumidification consumable. Different types of dehumidification consumables have different water absorption capacities; a greater water absorption capacity of the dehumidification consumable corresponds to a greater impact threshold.

In some embodiments, the government safety supervision management platform retrieves from a fourth preset lookup table based on the consumable type of the dehumidification consumable to obtain the water absorption capacity of the dehumidification consumable, and determines the impact threshold based on the water absorption capacity.

The fourth preset lookup table contains a correspondence relationship between consumable types of dehumidification consumables and water absorption capacity corresponding to each of the consumable types. The fourth preset lookup table may be constructed through experiments.

The stronger the water absorption capacity of the dehumidification consumable, the slower a humidity increase rate within the pipeline vault, enabling extended normal operation of the ancillary facility. Therefore, the impact threshold may be appropriately increased.

In some embodiments, in response to the humidity impact coefficient of the pipeline vault being greater than a ratio of the impact threshold to the pipeline vault importance value, the government safety supervision management platform determines that the dehumidification consumable requiring replacement exists in the pipeline vault. Otherwise, the government safety supervision management platform determines that no dehumidification consumables requiring replacement exists in the pipeline vault.

In some embodiments, the government safety supervision management platform determines whether the dehumidification consumable requiring replacement exists in the pipeline vault based on the humidity impact coefficient, the impact threshold, the pipeline vault importance value, and an impact reliability value.

The impact reliability value indicates a reliability degree of the humidity impact coefficient. In some embodiments, the government safety supervision management platform determines the impact reliability value using Equation (2):

$$C = \frac{{P}_{1} \cdot A}{\vert {P}_{1} - {P}_{2} \vert} \qquad ( 2 )$$

wherein C denotes the impact reliability value, P₁ denotes the humidity impact coefficient determined using the manner described in step 320, P₂ denotes the humidity impact coefficient determined using Equation (1), A denotes the water absorption capacity of the dehumidification consumable.

In some embodiments, in response to the humidity impact coefficient, the impact threshold, the pipeline vault importance value, and the impact reliability value satisfying Equation (3), the government safety supervision management platform determines that the dehumidification consumable requiring replacement exists in the pipeline vault. Otherwise, the government safety supervision management platform determines that no dehumidification consumables requiring replacement exists in the pipeline vault.

$$P > C \times T / {I}_{m} \qquad ( 3 )$$

wherein P denotes the humidity impact coefficient, C denotes the impact reliability value, T denotes the impact threshold, and Iₘ denotes the pipeline vault importance value. P may be any one of the humidity impact coefficient P₁ or the humidity impact coefficient P₂, or a combination of the humidity impact coefficient P₁ and the humidity impact coefficient P₂ (e.g., a weighted sum or an average of the humidity impact coefficient P₁ and the humidity impact coefficient P₂).

In some embodiments of the present disclosure, whether the dehumidification consumable requiring replacement exists in the pipeline vault is determined based on the reliability degree of the humidity impact coefficient. This approach can reduce misjudgments, avoid premature replacement that may lead to material waste, and prevent delayed replacement that may result in failures.

Pipeline vaults with higher importance levels require stricter humidity control. In some embodiments of the present disclosure, whether the dehumidification consumable requiring replacement exists in the pipeline vault is determined based on the pipeline vault importance value, thereby enabling independent assessments for pipeline vaults with different importance levels and ensuring that each pipeline vault maintains an appropriate degree of dryness.

Some embodiments of the present disclosure further provide a non-transitory computer-readable storage medium storing computer instructions. When a computer reads the instructions from the storage medium, the computer executes the method for dehumidification monitoring of an ancillary facility in a smart gas pipeline network described in one or more embodiments of the present disclosure.

Having thus described the basic concepts, it may be rather apparent to those skilled in the art after reading this detailed disclosure that the foregoing detailed disclosure is intended to be presented as illustrative example and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of the present disclosure.

Moreover, certain terminology has been configured to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this disclosure are not necessarily all referring to the same embodiment. Furthermore, the particular features, structures, or characteristics may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be noted that in the foregoing description of embodiments of the present disclosure, various features are sometimes grouped together in a single embodiment, figure, or description thereof for the purpose of streamlining the disclosure aiding in the understanding of one or more of the various inventive embodiments. This way of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties configured to describe and claim certain embodiments of the present disclosure are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameter set forth in the written description and attached claims are approximations that may vary depending upon the desired properties sought to be obtained by a particular embodiment. In some embodiments, the numerical parameter should be construed in light of the number of reported significant digits and by applying ordinary rounding techniques. Notwithstanding that the numerical ranges and parameter setting forth the broad scope of some embodiments of the present disclosure are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrating of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. An Internet of Things (IoT) system for dehumidification monitoring of an ancillary facility in a smart gas pipeline network, comprising: a government safety supervision management platform, a government safety supervision sensor network platform, a government safety supervision object platform, a gas company sensor network platform, a gas equipment object platform, and a gas maintenance object platform; wherein
the gas equipment object platform includes a humidity monitoring component and a dehumidification component, the humidity monitoring component is configured to collect humidity monitoring data, the humidity monitoring data includes at least one of a pipeline environment humidity level or a pipeline vault humidity level, the dehumidification component is configured to dehumidify a pipeline vault, the gas maintenance object platform includes an interactive device, and the government safety supervision management platform is configured to:
based on the government safety supervision sensor network platform, obtain, through the government safety supervision object platform and from the gas company sensor network platform, the humidity monitoring data collected by the gas equipment object platform;
determine a dehumidification parameter based on the humidity monitoring data and a downstream feature of a gas pipeline, wherein the dehumidification parameter includes a self-cleaning cycle of the dehumidification component, and the downstream feature includes a gas usage frequency of downstream gas; and
send the dehumidification parameter to the dehumidification component, and control the dehumidification component to perform self-cleaning based on the dehumidification parameter.

2. The IoT system of claim 1, wherein the dehumidification parameter further includes a self-cleaning intensity of the dehumidification component; and the government safety supervision management platform is further configured to:
obtain terrain data, wherein the terrain data includes an altitude;
determine a humidity impact coefficient of the pipeline vault based on the terrain data and the humidity monitoring data; and
determine the dehumidification parameter based on the humidity impact coefficient of the pipeline vault and the downstream feature of the gas pipeline.

3. The IoT system of claim 2, wherein the government safety supervision management platform is further configured to:
determine the humidity impact coefficient of the pipeline vault through a coefficient determination model based on a gas transmission parameter of the gas pipeline, the terrain data, and the humidity monitoring data, the coefficient determination model being a machine learning model.

4. The IoT system of claim 3, wherein an input of the coefficient determination model includes an ancillary facility feature and future humidity monitoring data, and the ancillary facility feature includes an ancillary facility type.

5. The IoT system of claim 3, wherein training of the coefficient determination model includes:
verifying an initial model trained on a training set by using a validation set, testing the initial model that passes validation of the validation set by using a test set, and designating the initial model that passes testing of the test set as the coefficient determination model; wherein
the training set, the test set, and the validation set are obtained based on historical data, wherein a data volume of the training set, a data volume of the test set, and a data volume of the validation set form a first preset ratio, and there is no data overlap among the training set, the test set, and the validation set;
different training samples have different learning rates, and the learning rate of a training sample is related to maintenance data of a sample ancillary facility corresponding to the training sample.

6. The IoT system of claim 1, wherein the dehumidification component further includes a dehumidification consumable; the dehumidification parameter further includes a dehumidification consumable requiring replacement; and the government safety supervision management platform is further configured to:
determine the future humidity monitoring data based on the humidity monitoring data; and
determine the dehumidification parameter based on the future humidity monitoring data and the downstream feature of the gas pipeline.

7. The IoT system of claim 6, wherein the government safety supervision management platform is further configured to:
determine the future humidity monitoring data through a humidity prediction model based on the humidity monitoring data, an ancillary facility feature, terrain data, a consumable type of the dehumidification consumable, a gas transmission parameter of the gas pipeline, and a previous replacement time of the dehumidification consumable, the humidity prediction model being a machine learning model.

8. The IoT system of claim 6, wherein the government safety supervision management platform is further configured to:
determine a humidity impact coefficient of the pipeline vault based on the future humidity monitoring data;
determine a pipeline vault importance value of the pipeline vault based on the downstream feature of the gas pipeline; and
determine whether the dehumidification consumable requiring replacement exists in the pipeline vault based on the humidity impact coefficient of the pipeline vault, the pipeline vault importance value, and an impact threshold.

9. The IoT system of claim 8, wherein the government safety supervision management platform is further configured to:
determine whether the dehumidification consumable requiring replacement exists in the pipeline vault based on the humidity impact coefficient, the impact threshold, the pipeline vault importance value, and an impact reliability value, wherein the impact reliability value is related to the humidity impact coefficient and a consumable type of the dehumidification consumable.

10. The IoT system of claim 1, wherein,
the government safety supervision sensor network platform is communicatively connected to the government safety supervision management platform and the government safety supervision object platform; and the gas company sensor network platform is communicatively connected to the government safety supervision object platform, the gas maintenance object platform, and the gas equipment object platform.

11. A method for dehumidification monitoring of an ancillary facility in a smart gas pipeline network, executed by a government safety supervision management platform of an Internet of Things (IoT) system for dehumidification monitoring of the ancillary facility in the smart gas pipeline network, the method comprising:
based on a government safety supervision sensor network platform, obtaining, through a government safety supervision object platform and from a gas company sensor network platform, humidity monitoring data collected by a gas equipment object platform, wherein the gas equipment object platform includes a humidity monitoring component and a dehumidification component, the humidity monitoring component is configured to monitor the humidity monitoring data, the humidity monitoring data includes at least one of a pipeline environment humidity level or a pipeline vault humidity level, the dehumidification component is configured to dehumidify a pipeline vault, and a gas maintenance object platform of the IoT system includes an interactive device;
determining a dehumidification parameter based on the humidity monitoring data and a downstream feature of a gas pipeline, wherein the dehumidification parameter includes a self-cleaning cycle of the dehumidification component, and the downstream feature includes a gas usage frequency of downstream gas; and
sending the dehumidification parameter to the dehumidification component, and controlling the dehumidification component to perform self-cleaning based on the dehumidification parameter.

12. The method of claim 11, wherein the dehumidification parameter further includes a self-cleaning intensity of the dehumidification component, and the determining a dehumidification parameter based on the humidity monitoring data and a downstream feature of a gas pipeline includes:
obtaining terrain data, wherein the terrain data includes an altitude;
determining a humidity impact coefficient of the pipeline vault based on the terrain data and the humidity monitoring data;
determining the dehumidification parameter based on the humidity impact coefficient of the pipeline vault and the downstream feature of the gas pipeline.

13. The method of claim 12, wherein the determining a humidity impact coefficient of the pipeline vault based on the terrain data and the humidity monitoring data includes:
determining the humidity impact coefficient of the pipeline vault through a coefficient determination model based on a gas transmission parameter of the gas pipeline, the terrain data, and the humidity monitoring data, the coefficient determination model being a machine learning model.

14. The method of claim 13, wherein an input of the coefficient determination model includes an ancillary facility feature and future humidity monitoring data, and the ancillary facility feature includes an ancillary facility type.

15. The method of claim 13, wherein training of the coefficient determination model includes:
verifying an initial model trained on a training set by using a validation set, testing the initial model that passes validation of the validation set by using a test set, and designating the initial model that passes testing of the test set as the coefficient determination model; wherein
the training set, the test set, and the validation set are obtained based on historical data, wherein a data volume of the training set, a data volume of the test set, and a data volume of the validation set form a first preset ratio, and there is no data overlap among the training set, the test set, and the validation set; and
different training samples have different learning rates, and the learning rate of a training sample is related to maintenance data of a sample ancillary facility corresponding to the training sample.

16. The method of claim 11, wherein the dehumidification component further includes a dehumidification consumable, the dehumidification parameter further includes a dehumidification consumable requiring replacement, and the determining a dehumidification parameter based on the humidity monitoring data and a downstream feature of a gas pipeline includes:
determining future humidity monitoring data based on the humidity monitoring data; and
determining the dehumidification parameter based on the future humidity monitoring data and the downstream feature of the gas pipeline.

17. The method of claim 16, wherein the determining future humidity monitoring data based on the humidity monitoring data includes:
determining the future humidity monitoring data through a humidity prediction model based on the humidity monitoring data, an ancillary facility feature, terrain data, a consumable type of the dehumidification consumable, a gas transmission parameter of the gas pipeline, and a previous replacement time of the dehumidification consumable, the humidity prediction model being a machine learning model.

18. The method of claim 16, wherein the determining the dehumidification parameter based on the future humidity monitoring data and the downstream feature of the gas pipeline includes:
determining a humidity impact coefficient of the pipeline vault based on the future humidity monitoring data;
determining a pipeline vault importance value of the pipeline vault based on the downstream feature of the gas pipeline; and
determining whether the dehumidification consumable requiring replacement exists in the pipeline vault based on the humidity impact coefficient of the pipeline vault, the pipeline vault importance value, and an impact threshold.

19. The method of claim 18, wherein the determining whether the dehumidification consumable requiring replacement exists in the pipeline vault based on the humidity impact coefficient of the pipeline vault, the pipeline vault importance value, and an impact threshold includes:
determining whether the dehumidification consumable requiring replacement exists in the pipeline vault based on the humidity impact coefficient, the impact threshold, the pipeline vault importance value, and an impact reliability value, wherein the impact reliability value is related to the humidity impact coefficient and a consumable type of the dehumidification consumable.

20. A non-transitory computer-readable storage medium, storing computer instructions, wherein when reading the computer instructions in the storage medium, a computer executes a method for dehumidification monitoring of an ancillary facility in a smart gas pipeline network, executed by a government safety supervision management platform of an Internet of Things (IoT) system for dehumidification monitoring of an ancillary facility in a smart gas pipeline network, the method comprising:
based on a government safety supervision sensor network platform, obtaining, through a government safety supervision object platform and from a gas company sensor network platform, humidity monitoring data collected by a gas equipment object platform, wherein the gas equipment object platform includes a humidity monitoring component and a dehumidification component, the humidity monitoring component is configured to monitor the humidity monitoring data, the humidity monitoring data includes at least one of a pipeline environment humidity level or a pipeline vault humidity level, the dehumidification component is configured to dehumidify a pipeline vault, and a gas maintenance object platform of the IoT system includes an interactive device;
determining a dehumidification parameter based on the humidity monitoring data and a downstream feature of a gas pipeline, wherein the dehumidification parameter includes a self-cleaning cycle of the dehumidification component, and the downstream feature includes a gas usage frequency of downstream gas; and
sending the dehumidification parameter to the dehumidification component, and controlling the dehumidification component to perform self-cleaning based on the dehumidification parameter.
